(19) United States
(12) Patent Application Publication
(10) Pub. No.: US 2003/0070849 A1
(43) Pub. Date: Apr. 17, 2003

(54) Auxiliary power unit for vehicles

(76) Inventor: Clark Thomas Whittaker, Mocksville, NC (US)

Correspondence Address: W. Scott Petty, King & Spalding, 1914 Peachtree Street 45th Floor, Atlanta, GA, 30303-1763, US

(21) Appl. No.: 09/981,572

(22) Filed: Oct. 17, 2001

(51) Int. Cl. B60K 11/00

(52) U.S. Cl. 180/68.2; 180/65.3

(57) ABSTRACT

An auxiliary cooling, heating and electrical power unit for vehicles with large capacity internal combustion engines. The unit includes a small capacity auxiliary engine driving an auxiliary coolant pump, alternator and refrigerant compressor, a separate air conditioning unit and an auxiliary battery. A heat exchanger attached to the auxiliary engine transfers heat from the exhaust gases to coolant circulating through the heat exchanger. The coolant pump circulates the heated coolant through the main heater core and the main engine before returning to the heat exchanger. The refrigerant compressor provides refrigerant to the auxiliary air conditioning unit. The auxiliary alternator provides electrical power to the auxiliary battery, the main battery and other electrical equipment. An interlock prevents the simultaneous operation of the auxiliary engine and the main engine. The auxiliary unit allows the main engine to be shutdown during extended stops while maintaining heating, cooling and electrical power to the truck.

### BACKGROUND OF THE PRESENT INVENTION

1. Field of the Present Invention

The present invention relates to the field of power units, in particular auxiliary power units for use on large vehicles such as tractor-trailers, to supply electrical power, heating and cooling to the vehicle engine and interior when the vehicle's main engine is not operating.

2. Background Art

Large vehicles, such as tractor-trailers, are usually powered by high capacity diesel engines. These diesel engines operate more efficiently under a load rather than at idling speed. Indeed, long periods of idling not only increases fuel consumption but also causes more engine wear and increases the pollutants in the environment. The most obvious response is to limit the amount of time the high capacity diesel engines remain at idle. However, there are numerous disadvantages to limiting the idling time of the diesel engine of large vehicles.

Diesel engines are typically very hard to start in cold weather. Further, regardless of the ambient temperature, each “cold” start, i.e., starting an engine with the lubricants at ambient temperature and gravitationally settled rather than well distributed throughout the engine, increases the wear on the components of the engine because the “cold” lubricant does not flow through the engine as readily as lubricant at operating temperature. Additionally, heating and cooling of the vehicle interior is directly dependent on the operation of the engine. When a driver stops to rest, especially in extremely hot or cold conditions, the driver must keep the engine operating at idling speed so the interior can continue to be heated or cooled. While the heating and cooling of the interior may seem to be an issue of driver comfort, providing an environment in which the driver can rest is also an issue of safety, not only for the driver but for occupants of other vehicles. Also, in extreme temperature conditions, being able to continually keep the interior of the vehicle heated or cooled may be a question of protecting the life of the driver. Further, the continual operation of the vehicle engine when the vehicle is stopped also provides electrical power to the vehicle's electrical devices such as the lights and communications. While the electrical devices can be operated by electrical power from the batteries, the batteries have a finite charge from which to operate such devices and still have enough reserve power to start the diesel engine.

To address these problems, auxiliary power units have been suggested for large vehicles. For example, Eckstein, U.S. Pat. No. 4,448,157, discloses an auxiliary power system having an engine that provides power to an auxiliary air conditioner refrigerant compressor, an alternator and a coolant pump. The exhaust from the auxiliary engine is routed through a heat exchanger where it heats coolant from the main engine. The heated coolant is pumped through and cools the auxiliary engine and then travels to the existing heater and to the main engine before it is returned to the heat exchanger. The lines from the auxiliary air conditioner compressor are connected to the existing refrigerant lines so that compressed refrigerant from the auxiliary air conditioner compressor can be supplied to the existing air conditioner unit. The auxiliary alternator is connected to the main battery and the vehicle's electrical devices. The main engine and the auxiliary engine share the main fuel tank and main battery.

This construction requires the coolant to flow not only through the heat exchanger, but also through the auxiliary engine. Because of the additional transfer of heat from the auxiliary engine to the coolant, the temperature of the coolant leaving the auxiliary engine may exceed the desired temperature for the main heater core and the main engine. The excessive coolant temperature necessitates the addition of a radiator between the coolant outlet of the auxiliary engine and the main engine. The auxiliary radiator and necessary piping adds weight to the auxiliary power unit, increasing the empty weight of the vehicle and consequently decreasing the amount of load the vehicle can carry. The existing air conditioner unit must be modified to connect the refrigerant lines from the auxiliary air conditioner compressor. Finally, the auxiliary power unit shares the main battery which places an additional strain on the main battery, potentially shortening its life. Furthermore, if the main battery is drained, then the auxiliary engine can not be started. Without the auxiliary engine operating, the auxiliary alternator can not recharge the drained main battery and, hence, the main engine remains inoperable.

Another auxiliary power system for vehicles is disclosed in Keedy, U.S. Pat. No. 4,611,466. Keedy includes an auxiliary engine connected to the main alternator. In one embodiment, the exhaust from the auxiliary engine flows through a heat exchanger to heat coolant from the main engine. A second embodiment includes an auxiliary air conditioner compressor but no heat exchanger. In a third embodiment, the auxiliary engine uses a different fuel than the main engine and, therefore, has a separate fuel tank. In each embodiment, the main engine and the auxiliary engine share the main battery. However, unlike Eckstein, the auxiliary engine in Keedy may include a manual (pull rope) starter as well as an electric starter. Thus, even if the main battery is drained, the auxiliary engine may be operable and capable of driving the main alternator to recharge the main battery.

Although Keedy has some advantages over Eckstein, the auxiliary power system in Keedy does not provide the range of uses that Eckstein does. In particular, the air conditioning compressor for auxiliary cooling of the interior and the heat exchanger utilizing the exhaust from the auxiliary engine are not available in the same construction. Further, the main engine and the auxiliary engine can be operated simultaneously, creating a risk that the coolant system or the heating system may be over pressurized by the simultaneous operation of two coolant pumps (one for the main coolant system and one for the auxiliary power system). While the auxiliary engine in Keedy includes a manual starter, in order to use the manual starter, it must be accessible by the truck operator, have enough open space around it so that the action required by the truck operator to manually start the auxiliary engine is not hampered or prevented, and be useable by truck operators having widely disparate physical capabilities. Finally, the main alternator, the main interior heating system, and the main exhaust system must be modified to accommodate the auxiliary power system, thus making retrofit expensive and time consuming.

Another auxiliary heating and cooling system for large vehicles is disclosed in Greer, U.S. Pat. No. 4,682,649. The auxiliary unit in Greer includes an engine, an auxiliary air conditioner compressor, an auxiliary coolant pump and an auxiliary alternator. The compressor, coolant pump and alternator are driven by belts connected to the auxiliary engine. A heat exchanger is attached to the exhaust outlet of the auxiliary engine and is used to heat coolant for the main engine. The auxiliary engine is cooled by coolant from the main engine that flows through an inlet line that is separate from the inlet line to the heat exchanger. The main heating system is not modified in Greer and the lines to and from the auxiliary system are connected to the main engine. The auxiliary air conditioner compressor supplies compressed refrigerant to the existing refrigerant lines of the main air conditioner. The auxiliary alternator is connected to the main battery. The main engine and the auxiliary engine share a single fuel tank and the main battery

This construction requires two different outlet lines from the main engine—one to the heat exchanger and one to the auxiliary engine, thus increasing the weight of the auxiliary system and the modifications required to the main engine. The refrigerant lines from the auxiliary air conditioner compressor are connected to the refrigerant lines of the main air conditioner unit, also requiring modifications to the main air conditioning unit. Further, because the coolant heated in the heat exchanger circulates through the main engine without directly flowing to the main interior heater, the main heating system may not provide sufficient heat to the interior for the driver. Finally, as with Eckstein and Keedy, the main engine and the auxiliary engine share the main battery so if the main battery is drained, then the auxiliary engine can not be started, leaving the vehicle's battery unable to be recharged and the main engine inoperable.

Thus, mindful of the disadvantages of the disclosed auxiliary power systems, a need exists to provide an alternative power supply for large vehicles that eliminates the need for constant operation of the high capacity diesel engine at idling speed, thereby saving fuel, wear on the engine and decreasing the pollutants released to the environment, while preserving the advantages of having a constant source of heating for the engine and the interior, cooling for the interior and power for charging the main battery and operating the vehicle's electrical devices. Additionally, the need exists to provide this type of auxiliary power unit that is not dependent on the main battery to be operable, does not pose any risk of over-pressurizing the coolant system due to the simultaneous operation of the main and auxiliary coolant pumps, and requires little modification to the existing systems to be installed, to reduce the cost of adding the auxiliary power unit to a vehicle.

### SUMMARY OF THE INVENTION

The present invention addresses these needs by providing an improved auxiliary cooling, heating and power supply unit for trucks that have a main internal combustion engine. The unit may be attached to any truck, either as original equipment or retrofit. The auxiliary unit includes an auxiliary engine, alternator, coolant pump and air conditioning refrigerant compressor, each driven by the auxiliary engine. A heat exchanger is attached to the exhaust of the auxiliary engine. Coolant from the main engine is heated by the exhaust from the auxiliary engine within the heat exchanger. The coolant is circulated through pipes connected to the heat exchanger on one end and to the main heater core inlet line and at some location on or near the main engine on the other end. The auxiliary coolant pump is attached to the outlet side of the heat exchanger to circulate the coolant. Flow from the auxiliary unit to the main heater core inlet line is controlled by a coolant valve located on the outlet side of the heat exchanger.

The auxiliary unit also includes an auxiliary air conditioning unit for cooling the interior of the truck. The auxiliary air conditioning unit is supplied with compressed refrigerant by the auxiliary air conditioning refrigerant compressor attached to the auxiliary engine. The auxiliary air conditioning unit is completely separate from the main air conditioning unit and is smaller in size.

The auxiliary unit also includes a separate battery that is used to start the auxiliary engine. The auxiliary alternator is connected to the auxiliary battery, as well as to the main battery and the electrical devices installed on the truck. When the auxiliary engine is operating, the auxiliary alternator is capable of recharging the auxiliary battery, the main battery and supplying electrical power to the truck's electrical devices.

### BRIEF DESCRIPTION OF THE DRAWINGS

Further features, embodiments, and advantages of the present invention will become apparent from the following detailed description with reference to the drawings, wherein:

FIG. 1 is a schematic diagram of the auxiliary power unit embodied by the present invention with associated main units; and

FIG. 2 is a schematic side elevation of the auxiliary engine and heat exchanger (shown in cutout view).

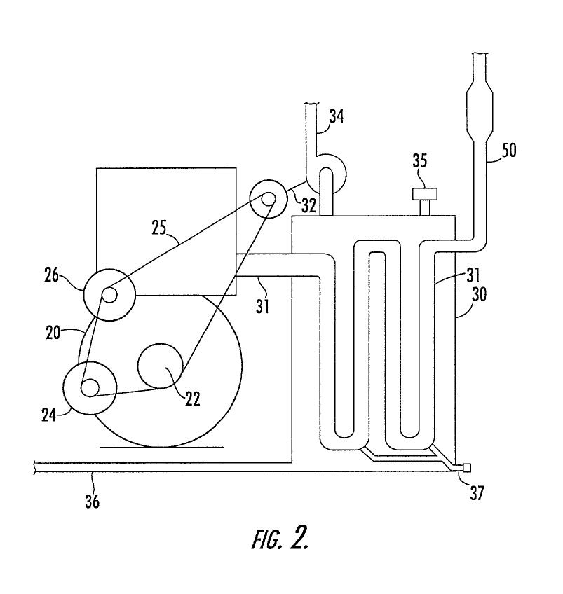

### DETAILED DESCRIPTION OF THE PREFERRED EMBODIMENTS

A vehicle, for example a large truck, has a passenger compartment (not shown), a main internal combustion engine 105, a main engine cooling system, a main battery 142, a main heating system for the passenger compartment, and a main electrical system (not shown). The main engine 105, preferably a large capacity one that uses diesel-fuel, is used to drive the vehicle and the main electrical system. A main starter motor 86, connected to the main battery 60, is used to start the main engine 105. The main engine cooling system includes, among other things, a quantity of main liquid coolant that circulates through the main engine.

The main battery 142 provides electrical power to the main starter motor 86 and to the main electrical system of the vehicle. The main electrical system may include external and internal lights, communication equipment such as radios, instrumentation and control devices. When the main engine 105 is operating, a main alternator recharges the main battery 142 and provides electrical power to the main electrical system.

The main heating system includes a main heater core 114 that is located near the passenger compartment, a main heater inlet line 110 connected to the main engine 105 and the main heater core 114, and a main heater outlet line 112 connected to the main heater core 114 and the main engine 105. Heated main liquid coolant flows from the main engine 105, through the main heater inlet let 110 and into the main heater core 114, thereby heating the passenger compartment, before returning to the main engine 105 via the main heater outlet line 112.

Referring now to the drawings, in which like numerals represent like components throughout the several views, an auxiliary vehicle power supply system 10, in accordance with the preferred embodiments of the present invention, is shown and described, and basically comprises an auxiliary engine 20, an auxiliary heat exchanging system, an auxiliary air conditioner system, and an auxiliary battery 60 with an auxiliary alternator 26.

The auxiliary engine 20, has a small capacity preferably between about 5 hp and about 8 hp. In a preferred embodiment, the auxiliary engine 20 uses diesel fuel, preferably from the same source as the main engine 105. The auxiliary engine 20 is started by a starter motor 84, that is connected to and receives its electrical power from the auxiliary battery 60. A power pulley 22, is connected to and driven by the auxiliary engine 20. A belt 25 connects the power pulley 22 to the auxiliary alternator 26, an auxiliary compressor 24, and an auxiliary coolant supply pump 32. An exhaust system 50 is connected to the auxiliary engine 20, and is used to remove hot exhaust gases generated by the auxiliary engine 20.

The auxiliary heat exchanging system includes a heat exchanger 30, the auxiliary coolant supply pump 32, a supply line 34, a return line 36 and an auxiliary coolant supply valve 82. The heat exchanger 30 comprises a coolant tank 33 enclosing a tube coil 31. The tube coil 31 is attached to the exhaust system 50 so that the hot exhaust gases from the auxiliary engine 20 flow through the tube coil 31 within the coolant tank 33. A portion of the main liquid coolant circulates through the coolant tank 33. The auxiliary coolant supply pump 32 is attached adjacent to the coolant tank 33 and is connected to one end of the supply line 34. The opposite end of the supply line 34 is connected to the main heater inlet line 110. The return line 36 is connected at one end to the coolant tank 33. The opposite end is also connected to the main heater inlet line 110 such that the return line 36 is between the supply line 34 and the main engine 105. An auxiliary coolant supply valve 82 is connected to the main heater inlet line 110 between the supply line 34 and the return line 36 and controls the amount of main liquid coolant that is introduced to the main heater inlet line. The auxiliary coolant supply valve 82 may be manually controlled by a truck operator or remotely controlled by a sensor. A pressure relief valve 35 is installed on the coolant tank 33 of the heat exchanger 30 to prevent the heat exchanger 30 from being overpressurized. Condensate drains 37 are connected to low points of the tube coil 31 so that any moisture introduced or created by the exhaust gases may be drained, preventing rust and other liquid damage to the tube coil 31.

During operation, the exhaust gases from the auxiliary engine 20 transfers heat across the tube coil 31 and into the portion of the main liquid coolant circulating within the coolant tank 33, heating the portion of main liquid coolant within the coolant tank 33. The heated portion of main liquid coolant is then pumped through the supply line 34, by the auxiliary coolant supply pump 32, and into the main heater inlet line 110. The heated portion main liquid coolant flows through the main heater core 114 and back to the main engine 105 via the main heater outlet line 112. In the meantime, another portion of the main liquid coolant flows from the main heater inlet line 110 into the return line 36 and back to the coolant tank 33, where the circulation loop begins again. The auxiliary coolant supply valve 82 is closed when the auxiliary vehicle power supply system 10 is operating, thereby forcing the main liquid coolant into the return line 36 so that heated main liquid coolant may be supplied to the main heater core 114 and the main engine 105. When the auxiliary vehicle power supply system 10 is not operating, the auxiliary coolant supply valve 82 is open, permitting main liquid coolant to flow from the main engine 105 to the main heater core 114 in the main heater inlet line 110 unimpeded.

The auxiliary air conditioning system is completely separate and independent from the main passenger compartment air conditioning unit 124. The auxiliary air conditioning system includes an air conditioner unit 70, the auxiliary compressor 24, a refrigerant inlet line 72, a refrigerant outlet line 74 and a condenser 76. The refrigerant inlet line 72 connects the auxiliary compressor 24 to the auxiliary air conditioner unit 70 so that compressed refrigerant may flow from the auxiliary compressor 24 to the auxiliary air conditioner unit 70. The refrigerant outlet line 74 connects the auxiliary air conditioner unit 70 to the auxiliary compressor 24. The condenser 76 is attached to the refrigerant outlet line 74 to remove condensate from the refrigerant after it has passed through the auxiliary air conditioner unit. 70 and before the refrigerant reaches the auxiliary compressor 24.

The use of a separate auxiliary air conditioning system eliminates any connection points that may leak and reduce the effectiveness of the air conditioning units and increase maintenance and repair costs. The inlet and outlet refrigerant lines 72, 74 do not connect to or otherwise interact with the inlet and outlet refrigerant lines 122, 123 for the main air conditioner unit 124. In addition, the use of a separate system eliminates the need to modify the existing air conditioning unit 124 or the main refrigerant lines 122, 123, thereby making the installation of the auxiliary air conditioning system and hence the auxiliary vehicle power supply system 10 less time consuming and less costly than auxiliary cooling systems that require connections to the main cooling system. Preferably, the auxiliary air conditioning system is a conventional passenger vehicle (e.g., car or sport utility vehicle) air conditioning unit which is more compact and lighter than one normally installed on large vehicles. The compact size should allow for easier placement and installation while the light weight limits the total amount of weight added to the vehicle by the installation of the auxiliary vehicle power supply system 10.

The auxiliary alternator 26 is connected to the auxiliary battery 60, the main battery 142 and main electrical system of the vehicle. The separate auxiliary battery 60, preferably a conventional passenger vehicle battery, allows the auxiliary engine 20 to be started even if the main battery 142 is completely discharged. With the auxiliary engine 20 operating, the auxiliary alternator 26 can then be used to charge the main battery 142, thus providing the vehicle operator with enough electrical power to start the main engine 105 and operate the vehicle. Without the auxiliary battery 60 available and the auxiliary alternator 26 being connected to the main battery 142, if the main battery 142 was completely discharged, then neither the main engine 105 nor the auxiliary engine 20 could be started, the main battery could not be charged, and hence, the main engine 105 and vehicle would be rendered inoperable. This situation can be especially dire if the truck is stranded in extremely cold weather and third-party assistance is not readily available.

In a preferred embodiment of the auxiliary vehicle power supply system 10, the auxiliary coolant supply valve 82 is in communication with an interlock 80 that is connected to the starter motor 84 on the auxiliary engine 20 and to the main starter motor 86 on the main engine 105. The interlock 80 prevents the simultaneous operation of the main engine 105 and the auxiliary engine 20. When the auxiliary engine 20 is operating and the auxiliary coolant supply valve 82 is closed, then the interlock 80 prevents the starter motor 86 of the main engine 105 to engage, thereby rendering the main engine 105 inoperable. This prevents coolant propelled by the main coolant pump 116 from entering the outlet pipe 34 and damaging the auxiliary coolant supply pump 32 and overpressurizing the heat exchanger 30. When the main engine 105 is operating and the auxiliary coolant supply valve 82 is open, the interlock prevents the starter 84 of the auxiliary engine 20 from engaging, rendering the auxiliary engine 20 inoperable to prevent overpressurization of the heat exchanger 30 and damage to the auxiliary coolant supply pump 32.

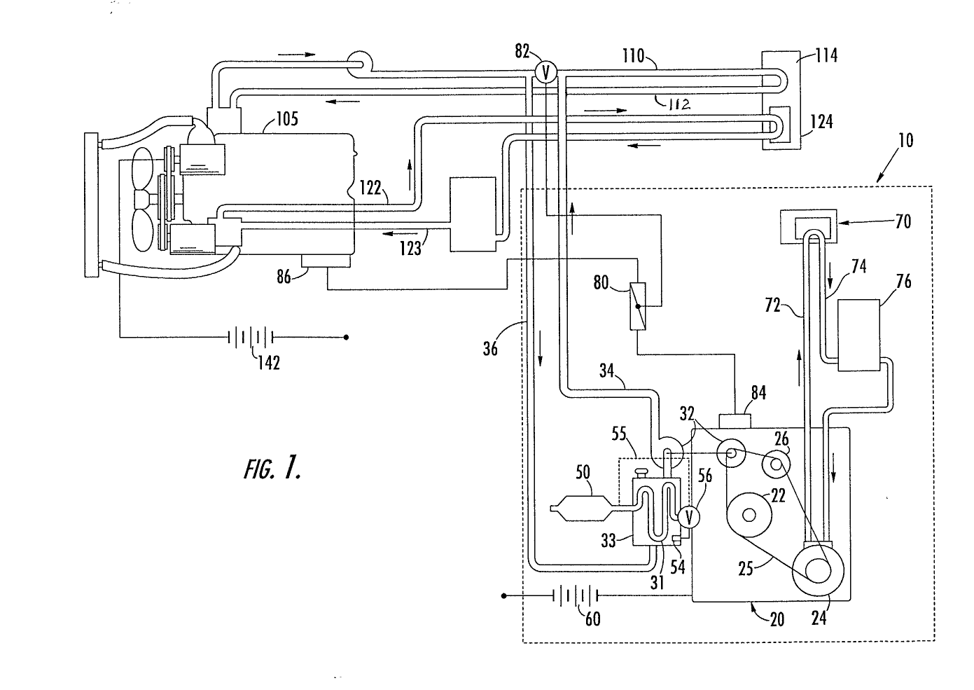

In a preferred embodiment, exhaust bypass line 55 routes the exhaust from the auxiliary engine 20 around the heat exchanger 30, bypassing the tube coil 31 within the coolant tank 33, as shown in FIG. 1. A temperature sensor 52 located within the coolant tank 33 is connected to bypass valve 56 and regulates its operation. At the initial operation of the auxiliary vehicle power supply system 10, the bypass valve 56 is closed, directing all of the exhaust from the auxiliary engine 20 through the tube coil 31 in the heat exchanger 30. When the coolant temperature, as measured by the temperature sensor 52, reaches a preset maximum value, a signal is sent to open the bypass valve 56 so that the exhaust from the auxiliary engine 20 is directed around the heat exchanger 30, reducing the temperature of the portion of main liquid coolant exiting the heat exchanger 30 that circulates to the main heater core 114 and the main engine 105. Having the exhaust from the auxiliary engine 20 bypass the heat exchanger 30 may be of particular importance during extremely hot weather when there is no need to provide heated coolant to the main heater core 114 and the main engine 105.

The balance of the auxiliary vehicle power supply system 10 may be mounted in any convenient location upon a vehicle. The auxiliary air conditioning unit 70 may be mounted on or near the passenger compartment of the vehicle. The supply line 34 may be connected to the main heater line 110 at any convenient location as may the return line 36. The connections may be accomplished by appropriately sized fittings and the supply and return lines 34, 36 may be made of any appropriate material that can withstand the operating pressures and temperatures experienced during operation of the auxiliary vehicle power supply system, for example reinforced flexible rubber tubing or flexible metal tubing. It is understood that the belt 25 connecting the power pulley 22 to the auxiliary coolant pump 32, the auxiliary alternator 26 and the auxiliary compressor 24 may be a single serpentine belt or multiple belts. The main engine 105 and the auxiliary engine 20 may use the same fuel and share the main fuel tank (not shown). An instrument panel for the auxiliary vehicle power supply system, including for example a starter switch, controls for the coolant valve 82 and instruments measuring operating time, engine temperature and alternator output, may be mounted in the vehicle passenger compartment or in another accessible location.

When a vehicle operator is traveling, the main engine 105, and associated heating and cooling components are in use. When the operator stops to rest or unload freight, or otherwise is not traveling, and the operator desires to keep the main engine 105 warm or to keep the passenger compartment cool or warm, then the main engine 105 must remain operating at low, idling speed. If the auxiliary vehicle power supply system 10, embodied in the present invention, is attached to the vehicle, then the operator may choose to shut down the main engine 105 and start the auxiliary engine 20, using the auxiliary battery 60. When the auxiliary engine 20 is operating and the auxiliary coolant supply valve 82 is closed, a portion of heated main liquid coolant from the auxiliary heat exchanging system circulates through the main heater core 114 (if desired) and the main engine 105, providing the necessary heating to the passenger compartment and the main engine 105. The operator may activate the auxiliary air conditioner system, to maintain the temperature of the passenger compartment at a comfortable level. The auxiliary alternator 26 maintains the charge in the auxiliary battery 60, charges the main battery 142 if needed and provides electrical power to the main electrical system of the vehicle. When the operator is ready to travel again, the auxiliary coolant supply valve 82 is opened, and the auxiliary engine 20 is shut off. The main engine 105, which has been kept at a temperature greater than ambient, is started and the vehicle is ready for travel.

If an engine has been operating under a load for a length of time and the ambient temperature is high, for example an over-the-road truck operating during summer, then when the engine is turned off, the heat within the engine continues to increase for some time due to the lack of coolant circulating through the engine. This increase may result in damage or excess wear to engine components, increasing overall maintenance costs. The auxiliary vehicle power supply system 10 may provide a means for the hot exhaust from the auxiliary engine 20 to bypass the heat exchanger 30, thus preventing the main liquid coolant circulating through the heat exchanger 30 to be heated by the exhaust. Because of this bypass capability of the present invention, if the main engine 105 is shut down and the auxiliary engine 20 started, then the main liquid coolant circulating through the main engine 105 from the bypassed heat exchanger 30 should be at a lower temperature than the main engine 105. Thus, the main engine 105 will be cooled immediately instead of experiencing a period of heating before cooling begins. Additionally, the temperature of the passenger compartment of the vehicle can quickly exceed comfort levels and safety levels in summer. The auxiliary air conditioning system can provide the necessary cooling to maintain an acceptable temperature within the passenger compartment.

Another situation in which the auxiliary vehicle power supply system 10 may be beneficial is any time that the main battery 142 is discharged beyond the capability to engage the starter motor 86 on the main engine 105, especially if the ambient temperature is extremely low. In this situation, not only will be engine lubricant require pre-heating so that the main engine 105 will start, but the main battery 142 must be recharged and the driver's safety in such hostile conditions must be considered. The auxiliary engine 20, being much smaller and hence easier to start in cold conditions, can be started. The main liquid coolant from the main engine 105 is circulated through the heat exchanger 30 where the exhaust from the auxiliary engine 20 heats the coolant. The heated coolant circulates through the main heater core 114, maintaining the passenger compartment at a safe temperature for the driver, and then through the main engine 105, thereby pre-heating the lubricant within the main engine 105 and the engine components. While the heated main liquid coolant is circulating and pre-heating the lubricant and engine components, the auxiliary alternator 26 is charging the main battery 142. At some time, the main battery 142 will have enough electrical power to initiate the starter motor 86 on the main engine 105, and the main engine lubricant will be sufficiently pre-heated to allow the main engine 105 to be started. Under extreme conditions, the auxiliary alternator 26 may also supply electrical power to the vehicle's main electrical system, especially the emergency radios, so that help can be summoned, especially if the vehicle is immobile for some reason (stuck in snow for example).

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

What is claimed is:

1. In a vehicle having a passenger compartment, a main internal combustion engine for driving the vehicle and a main electrical system, a main engine cooling system having a quantity of main liquid coolant, a main battery for supplying electrical power to the main engine and the main electrical system, and a main heating system for the passenger compartment including a main heater inlet line, a main heater core disposed in proximity to the passenger compartment, and a main heater outlet line, the main heater inlet line being connected to the main engine at one end and to the main heater core at an opposite end for supplying heated main liquid coolant from the main engine to the main heater core, and the main heater outlet line being connected to the main heater core at one end and to the main engine at an opposite end for returning the main liquid coolant from the main heater core to the main engine, the combination comprising:
an auxiliary internal combustion engine,
an auxiliary alternator driven by the auxiliary engine for providing electrical power to an auxiliary battery, the main battery, and the main electrical system,
an auxiliary air conditioning unit in communication with the passenger compartment, an auxiliary refrigerant compressor being connected to the auxiliary air conditioning unit by an auxiliary refrigerant supply line and an auxiliary refrigerant return line, the auxiliary refrigerant compressor being driven by the auxiliary engine, and
an auxiliary heat exchange system having an auxiliary liquid coolant pump being driven by the auxiliary engine, the auxiliary heat exchange system being connected to the main heating system for circulating a subquantity of main liquid coolant through the main heating system and the main engine.

2. In combination, a main vehicle power supply system for driving a vehicle and a main electrical system, a passenger compartment, an auxiliary vehicle power supply system for providing heating and cooling of the main vehicle power supply and the passenger compartment and electrical power to the electrical system, wherein
(a) the main vehicle power supply system comprising:
(i) a main internal combustion engine,
(ii) a main engine cooling system having a quantity of main liquid coolant,
(iii) a main battery for supplying electrical power to the main engine and the main electrical system, and
(iv) a main heating system for the passenger compartment including a main heater inlet line, a main heater core disposed in proximity to the passenger compartment, and a main heater outlet line, the main heater inlet line being connected to the main engine at one end and to the main heater core at an opposite end for supplying heated main liquid coolant from the main engine to the main heater core, and the main heater outlet line being connected to the main heater core at one end and to the main engine at an opposite end for returning the main liquid coolant from the main heater core to the main engine; and
(b) the auxiliary vehicle power supply system comprising
(i) an auxiliary internal combustion engine having an exhaust system,
(ii) an auxiliary battery for supplying electrical power to the auxiliary engine and the main electrical system;
(iii) an auxiliary alternator driven by the auxiliary engine for charging the auxiliary battery and the main battery and to provide electrical power to the auxiliary engine and the main electrical system,
(iv) an auxiliary compressor driven by the auxiliary engine for compressing a quantity of auxiliary refrigerant for an auxiliary air conditioner unit disposed upon the passenger compartment for cooling the passenger compartment, an auxiliary refrigerant supply line connected at one end to the auxiliary compressor and at an opposite end to the auxiliary air conditioning unit and an auxiliary refrigerant return line connected at one end to the auxiliary air conditioning unit and at an opposite end to the auxiliary compressor, and
(v) an auxiliary heating exchange system having an auxiliary tank for circulating a subquantity of main liquid coolant therethrough, the auxiliary tank being in proximity to the auxiliary engine, a coil extending through the auxiliary tank and connected to the auxiliary engine exhaust system for receiving hot exhaust gas therefrom, the coil within the auxiliary tank being in a heat transfer relationship with the subquantity of main liquid coolant circulating therethrough, an auxiliary coolant supply pump driven by the auxiliary engine and connected to the auxiliary tank, a supply line connecting the auxiliary coolant supply pump to a first position on the main heater inlet line for supplying the subquantity of main liquid coolant from the auxiliary tank to the main heater inlet line, a return line connecting the auxiliary tank to a second position on the main heater inlet line for returning the subquantity of main liquid coolant from the main heater inlet line to the auxiliary tank, said second position being located on the main heater inlet line between the main engine and said first position on the main heater inlet line such that the subquantity of main liquid coolant from the auxiliary tank circulates through the main heater core and the main engine before returning to the auxiliary tank, and a auxiliary heat exchange valve disposed within the main heater inlet line intermediate said first position and said second position on the main heater line to regulate the flow of the subquantity of main liquid coolant circulating therethrough.

3. The apparatus according to claim 1, wherein the main engine and the auxiliary engine have a common fuel system.

4. The apparatus according to claim 2, wherein an ignition interlock is in communication with the auxiliary heat exchange valve and connected to the main engine and the auxiliary engine for preventing the simultaneous operation thereof.

5. The apparatus according to claim 2, wherein the auxiliary heat exchange system includes an exhaust bypass for directing the exhaust gas from the auxiliary engine away from the coil within the auxiliary tank, the exhaust bypass comprising an exhaust pipe external of the auxiliary tank, a first end of the exhaust pipe connected to the coil at a location prior to the coil entering the auxiliary tank and connected at a second end to the coil at a location following the exit of the coil from the auxiliary tank, a temperature sensor located within the auxiliary tank, and a bypass valve disposed between the coil and the exhaust pipe, the temperature sensor being in communication with the bypass valve such that the temperature sensor actuates the bypass valve.

6. The apparatus according to claim 5, wherein the bypass valve is disposed between the coil and the first end of the exhaust pipe.

7. The apparatus according to claim 5, wherein the bypass valve is disposed between the coil and the second end of the exhaust pipe.

8. The apparatus according to claim 2, wherein the common fuel system has a common source of diesel fuel.

9. The apparatus according to claim 1, wherein the auxiliary engine is between approximately 5 hp and approximately 8 hp.

10. The apparatus according to claim 1, wherein the auxiliary engine is air cooled.

11. The apparatus according to claim 2 wherein a pressure relief valve is connected to the coil disposed within the auxiliary tank for preventing overpressurization of the auxiliary heat exchange system.

12. The apparatus according to claim 2, wherein the auxiliary vehicle power supply system can be installed as a retrofit to an existing vehicle.
